(19) United States
(12) Patent Application Publication
(10) Pub. No.: US 2004/0186965 A1
(43) Pub. Date: Sep. 23, 2004

(54) Method and system for accessing memory data

(75) Inventors: Chang-Cheng Yap, Hsin Chu (TW); Shih-Jen Chuang, Hsin Chu (TW); Tsai-Chun Hsieh, Hsin Chu (TW)

Correspondence Address: Mr. Steven M. Jensen, Mr. Peter F. Corless, EDWARDS & ANGELL, LLP, 101 Federal Street, Boston, MA, 02110, US

(73) Assignee: RDC Semiconductor Co., Ltd.

(21) Appl. No.: 10/735,348

(22) Filed: Dec. 11, 2003

(30) Foreign Application Priority Data
Dec. 26, 2002 (TW) 091137416

(51) Int. Cl. G06F 12/00

(52) U.S. Cl. 711/154; 711/137

(57) ABSTRACT

A method and a system for accessing memory data are provided. When an interface unit receives a memory accessing request from a processing unit, a non-cacheable memory buffer unit determines if a memory address corresponds to that in the memory accessing request; if yes, retrieving the memory address; if no, forwarding the memory accessing request to an arbitration unit for accessing data in a memory unit. During transmission of data from the memory unit to the interface unit, the non-cacheable memory buffer unit retrieves the data to simultaneously update stored data. The non-cacheable memory buffer unit pre-reads memory address data following the retrieved data to enhance a data reading speed for the processing unit. During writing data into the memory unit, the non-cacheable memory buffer unit updates the stored data by the written data if a memory address of the written data is identical to that of the stored data.

### FIELD OF THE INVENTION

The present invention relates to methods and systems for accessing memory data, and more particularly, to a method and system in the use of a non-cacheable memory buffer mechanism to improve efficiency of accessing memory data.

### BACKGROUND OF THE INVENTION

In accordance with the advancement of information technology, various electronic devices such as personal computer, notebook computer and so on are commercialized and provided with multiple functions and high performances to fulfill users' demands, for example, to achieve desirable data processing speed for being capable of calculating a huge amount of data, executing complicated application programs, uploading or downloading data through Internet, and playing multimedia for image and sound effects.

In reality, for improving the performances of the electronic devices, one common way is to upgrade the hardware of the electronic devices, for example to increase operating speed of a central processing unit, capacity of a random access memory unit, data accessing speed of a storage apparatus, or operating speed of a video adapter card or sound adapter card, or to improve data transmission bandwidth for a network communication system. It is believed that these upgrading strategies work especially for the operating speed of the electronic devices. However, hardware upgrading effectively increases the cost, which is usually unfavorable for users.

Besides, another common way to improve the electronic devices is to upgrade the software, for example to upgrade application programs, hardware driving programs, interface programs such as Direct X, and operating system programs. Compared to the hardware upgrading, the software upgrading is usually implemented via downloading from the network and thus would not increase the cost, except for application programs and operating system programs. However, the cost-free software upgrading usually can not achieve so good improvements as the hardware upgrading.

Therefore, how to enhance data processing speed of the electronic devices without significantly increasing the cost is desired to be solved. In the case of a personal computer, data accessing speed of the central processing unit can be improved by adding a Level 1 cache memory to the central processing unit, or further adding a Level 2 cache memory to the main board, to reduce the time for external data access. However, another problem encountered by operating the personal computer is that, access to region data in a common memory unit should be provided to both the central processing unit and an external device connected to the personal computer or an internal device built inside the personal computer. This requires a mechanism such as snooping for maintaining the region data correct. In other words, when the central processing unit writes data in the memory unit, if the written data has a memory address same as that of data stored in the Level 1 cache memory of the central processing unit, the data stored in the Level 1 cache memory are invalidated. Another solution is to set a particular region in the memory unit as a non-cacheable region; in other words, any device or unit having access to data stored in the non-cacheable region is not allowed to write data from the non-cacheable region to its own cache memory, so as to maintain systemic data uniform. On the contrary, the data in the non-cacheable region can only be read through the memory unit not through its own cache memory of such a device or unit, thereby adversely affecting working efficiency.

In view of the above, the problem to be solved herein is to provide a method and system for accessing memory data to enhance the operating performance of an electronic device without effectively increasing the cost for hardware upgrading.

### SUMMARY OF THE INVENTION

An objective of the present invention is to provide a method and system for accessing memory data, in the use of a non-cacheable memory buffer mechanism to reduce the times of internal units or modules in an electronic device to directly accessing data in a memory unit, so as to improve data processing efficiency.

Another objective of the present invention is to provide a method and system for accessing memory data, in the use of a non-cacheable memory buffer unit to pre-write continuous data to the non-cacheable memory buffer unit so as to improve data processing efficiency.

In accordance with the above and other objectives, the present invention proposes a system for accessing memory data, for providing a data storage buffer mechanism for a non-cacheable memory region in a memory unit of an electronic device; the system comprises: the memory unit for storing data to be accessed by the electronic device and having the non-cacheable memory region; an interface unit connected to a processing unit, for transmitting data between the processing unit and a unit or module of the electronic device; a non-cacheable memory buffer unit for accessing data in the non-cacheable memory region for the unit or module of the electronic device; and an arbitration unit for forwarding a memory accessing request to the memory unit to read data from the memory unit when the unit or module of the electronic device fails to read required data from the non-cacheable memory buffer unit.

In the use of the above memory data accessing system, a method for accessing memory data comprises the steps of: having an interface unit receive a memory accessing request from a processing unit, and allowing a non-cacheable memory buffer unit to conduct a comparison to determine if there is a memory address corresponding to that in the memory accessing request, if no, forwarding the memory accessing request to an arbitration unit for accessing data in the memory unit; then, having the non-cacheable memory buffer unit retrieve memory data during transmitting the data from the memory unit to the interface unit to update data stored in the non-cacheable memory buffer unit; and finally, having the non-cacheable memory buffer unit pre-read continuous memory address data following the retrieved data to enhance speed of accessing the continuous data for the processing unit.

Moreover, when the processing unit, apparatus or module of the electronic device writes data to the memory unit, the non-cacheable memory buffer unit is urged to compare if a memory address of the written data is consistent with that of data stored in the processing unit, apparatus or module of the electronic device. If yes, the non-cacheable memory buffer unit updates the data of the consistent memory address.

Compared to the conventional memory data accessing method and system, the above method and system according to the present invention employs a non-cacheable memory buffer mechanism to reduce the times of read data through the memory unit for the unit or module of the electronic device. Moreover, continuous memory data can be pre-read and stored in the non-cacheable memory buffer mechanism, thereby enhancing the efficiency of data processing.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing basic architecture of a memory data accessing system according to the invention; and

FIGS. 2(A) and 2(B) are flow charts showing procedural steps of a memory data accessing method according to the invention.

### DETAILED DESCRIPTION OF THE PREFERRED EMBODIMENTS

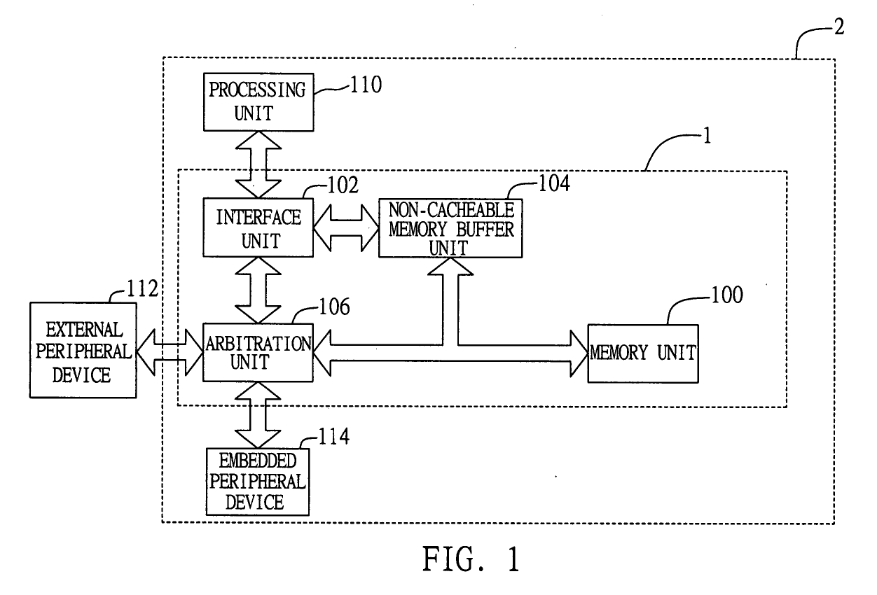

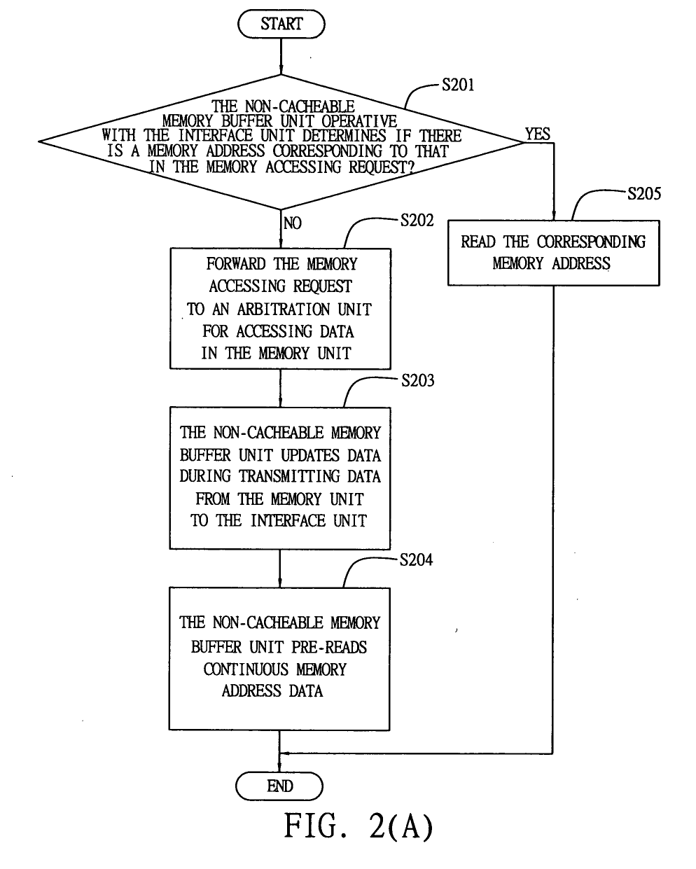

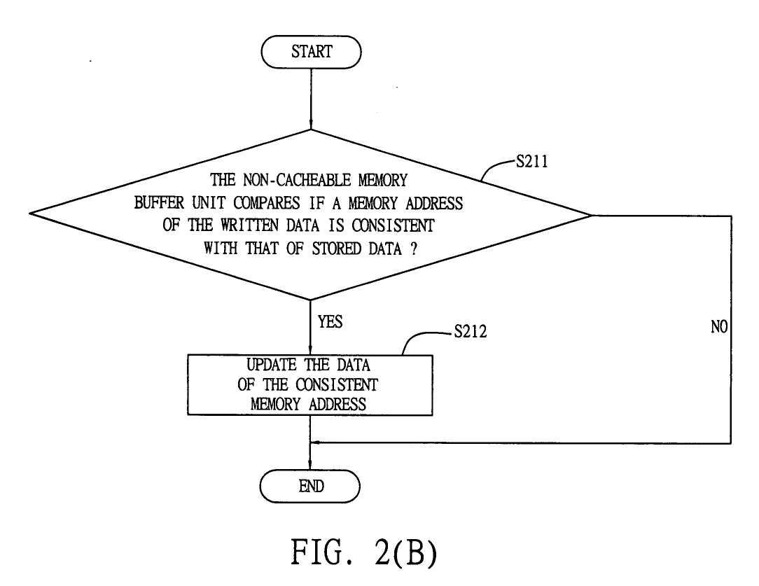

Preferred embodiments of a system and a method for accessing memory data according to the present invention are described in detail as follows with reference to FIGS. 1 and 2(A) to 2(B).

The memory data accessing system 1 shown in FIG. 1 can be used in an electronic device such as personal computer, notebook computer, palm computer, personal digital assistant, server, or workstation. In this embodiment, the memory data accessing system 1 is used in a person computer 2, and comprises a memory unit 100, an interface unit 102, a non-cacheable memory buffer unit 104 and an arbitration unit 106. The personal computer 2 comprises a processing unit 110, an external peripheral device 112, and an embedded peripheral device 114. The processing unit 110 is used for allowing the memory data accessing system 1 and units or modules of the personal computer 2 to retrieve, decode and implement commands and for transmitting and receiving data from other data sources through a data transmission path such as bus. The external peripheral device 112 is connected to the personal computer 2 via a data transmission interface such as cables to perform data transmission and is used for processing data. The embedded peripheral device 114 for processing data is internally built inside the personal computer 2. It should be understood that, the personal computer 2 actually contains more units or devices for its normal operation, while only associated parts or components relating to the memory data accessing system 1 according to the invention are described herein.

The memory unit 100 is under control of the processing unit 110 and is main data storage of the personal computer 2. In this embodiment, the memory unit 100 can be a random access memory (RAM) that is a volatile read/write memory, such as static RAM, dynamic RAM, synchronous dynamic RAM, or high-speed data-transmission synchronous dynamic RAM. The memory unit 100 allows the processing unit 110 to read commands from an input unit such as keyboard or mouse and to write data to a storage unit for data access. Further, the memory unit 100 can transmit data to an output device such as printer or display unit.

The interface unit 102 is connected with the processing unit 110. Upon receiving a signal from the processing unit 110 such as a memory accessing request for the memory unit 100, the interface unit 102 sends a signal to a corresponding unit or module connected thereto according to the signal from the processing unit 110 to perform data transmission.

The non-cacheable memory buffer unit 104 serves as a cache data storage mechanism for a non-cacheable memory region of the memory unit 100. In this embodiment, the memory unit 100 is set with a particular non-cacheable memory region. The memory data accessing system 1 and units or modules of the personal computer 2 are not allowed to write data from the non-cacheable memory region to a cache memory unit thereof. For example, if the processing unit 110 is built with a Level 1 cache memory, the processing unit 110 can not store data from the non-cacheable memory region into the Level 1 cache memory. Such a mechanism is to maintain systemic data of the memory data accessing system 1 and the personal computer 2 uniform. The non-cacheable memory buffer unit 104 plays an important role to avoid the prior-art drawback that the modules or units can only read data from the non-cacheable memory region through the memory unit 100 to delay data access.

It should be noted that, according to the memory accessing request from the processing unit 110, the non-cacheable memory buffer unit 104 operative with the interface unit 102 conducts a comparison to determine if there is a memory address corresponds to that in the memory accessing request. If yes, the interface unit 102 reads data from the non-cacheable memory region, thereby enhancing the efficiency of the processing unit 110 to access data in the non-cacheable memory region. Since the number of data entry in the non-cacheable memory buffer unit 104 is much smaller than the number of data stored in the non-cacheable memory region, the required hardware is less than the conventional Level 1 cache memory and Level 2 cache memory, thereby achieving the improvement in systemic operating performance without wasting a lot of cost.

Moreover, to maintain data stored in the non-cacheable memory buffer unit 104 and data stored in the memory unit 100 uniform, when the memory data accessing system 1 and modules or units of the personal computer 2 such as the external peripheral device 112 and the embedded peripheral device 114 write data in the memory unit 100, the non-cacheable memory buffer unit 104 conducts a comparison to determine if there is a memory address of stored data therein consistent with that of the written data. If yes, updating the non-cacheable memory buffer unit 104 and the memory unit 100 simultaneously with the written data. This assures the processing unit 110 to read the latest data from the non-cacheable memory buffer unit 104 according to the data with the consistent memory address.

The arbitration unit 106 is used to distribute systemic recourses for the memory data accessing system 1 and modules or units of the personal computer 2 in response to the memory accessing request from the processing unit 110. In this embodiment, when the processing unit 110, the external peripheral device 112 and the embedded peripheral device 114 simultaneously send memory accessing requests respectively to the memory unit 100, the arbitration unit 106 conducts the distribution of current systemic recourses according to the requests from those modules or units.

It is also to be noted that, when data corresponding to the memory accessing request from the processing unit 110 has not been stored in the non-cacheable memory buffer unit 104, the interface unit 102 forwards the memory accessing request to the arbitration unit 106, so as to allow the memory unit 100 to transmit the data to the interface unit 102. During this data transmission, the non-cacheable memory buffer unit 104 provides a snooping mechanism to simultaneously update data stored in the non-cacheable memory buffer unit 104 with the transmitted data. Moreover, continuous memory address data following the requested data by the processing unit 110 are pre-read and stored in the non-cacheable memory buffer unit 104, such that the processing unit 110 can read required data from the non-cacheable memory buffer unit 104 to thereby saving the time for accessing data and enhancing systemic operating efficiency.

In the use of the memory data accessing system 1, the method for accessing memory data can be accomplished by the following steps.

Referring to FIG. 2(A), it illustrates the procedural steps for the processing unit 110 to access memory data through the use of the memory data accessing system 1.

In step S201, the interface unit 102 is prompted to receive a memory accessing request from the processing unit 110, and the non-cacheable memory buffer unit 104 operative with the interface unit 102 conducts a comparison to determine if there is a memory data corresponding to that in the memory accessing request; if no, go to step S202; if yes, go to step S205.

In step S202, the memory accessing request is forwarded to the arbitration unit 106 for accessing memory data; then, go to step S203.

In step S203, during data transmission from the memory unit 100 to the interface unit 102, the non-cacheable memory buffer unit 104 is urged to retrieve the memory data to simultaneously update its stored data; then, go to step S204.

In step S204, the non-cacheable memory buffer unit 104 is urged to pre-read continuous memory address data following the retrieved data, to thereby enhancing the speed of accessing the continuous data for the processing unit 110.

In step S205, data of the corresponding memory address is read.

Referring to FIG. 2(B), it illustrates the procedural steps of pre-updating data in the non-cacheable memory buffer unit 104.

First, in step S211, when the processing unit 110 or other devices or modules such as the external peripheral device 112 and the embedded peripheral device 114 write data in the memory unit 100, the non-cacheable memory buffer unit 104 compares if a memory address of the written data from the processing unit 110 or the external peripheral device 112 and the embedded peripheral device 114 is consistent with that of data stored in the processing unit 110 or the external peripheral device 112 and the embedded peripheral device 114; if yes, go to step S212; if no, terminate the flow processes.

In step S212, the consistent memory data of the non-cacheable memory buffer unit 104 is updated with that of the written data.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for accessing memory data, for providing a data storage buffer mechanism for a non-cacheable memory region in a memory unit of an electronic device, the method comprising the steps of:
having an interface unit receive a memory accessing request from a processing unit, and allowing a non-cacheable memory buffer unit to conduct a comparison to determine if there is a memory address corresponding to that in the memory accessing request, if no, forwarding the memory accessing request to an arbitration unit for accessing data in the memory unit;
having the non-cacheable memory buffer unit retrieve memory data during transmitting the data from the memory unit to the interface unit to update data stored in the non-cacheable memory buffer unit; and
having the non-cacheable memory buffer unit pre-read continuous memory address data following the retrieved data to enhance speed of accessing the continuous data for the processing unit.

2. The method of claim 1, wherein the memory data is read when there is a memory address corresponding to that in the memory accessing request.

3. The method of claim 1, wherein the electronic device is selected from the group consisting of personal computer, notebook computer, palm computer, personal digital assistant, server, and workstation.

4. The method of claim 1, wherein the memory unit is selected from the group consisting of static random access memory, dynamic random access memory, synchronous dynamic random access memory, and high-speed data-transmission synchronous dynamic random access memory.

5. The method of claim 1, wherein the processing unit is a central processing unit or microprocessor.

6. A method for accessing memory data, for providing a data storage buffer mechanism for a non-cacheable memory region in a memory unit of an electronic device, the method comprising the steps of:
when a processing unit, apparatus or module of the electronic device writes data to the memory unit, having a non-cacheable memory buffer unit compare if a memory address of the written data is consistent with that of data stored in the processing unit, apparatus or module of the electronic device; and
when the consistency of memory address is verified, having the non-cacheable memory buffer unit update the data of the consistent memory address.

7. The method of claim 6, wherein the electronic device is selected from the group consisting of personal computer, notebook computer, palm computer, personal digital assistant, server, and workstation.

8. The method of claim 6, wherein the memory unit is selected from the group consisting of static random access memory, dynamic random access memory, synchronous dynamic random access memory, and high-speed data-transmission synchronous dynamic random access memory.

9. The method of claim 6, wherein the processing unit is a central processing unit or microprocessor.

10. The method of claim 6, wherein the apparatus is an external peripheral device or embedded peripheral device.

11. The method of claim 6, wherein the module is an external peripheral device or embedded peripheral device.

12. A system for accessing memory data, for providing a data storage buffer mechanism for a non-cacheable memory region in a memory unit of an electronic device, the system comprising:
the memory unit for storing data to be accessed by the electronic device and having the non-cacheable memory region;
an interface unit connected to a processing unit, for transmitting data between the processing unit and a unit or module of the electronic device;
a non-cacheable memory buffer unit for accessing data in the non-cacheable memory region for the unit or module of the electronic device; and
an arbitration unit for forwarding a memory accessing request to the memory unit to read data from the memory unit when the unit or module of the electronic device fails to read required data from the non-cacheable memory buffer unit.

13. The system of claim 12, wherein the electronic device is selected from the group consisting of personal computer, notebook computer, palm computer, personal digital assistant, server, and workstation.

14. The system of claim 12, wherein the memory unit is selected from the group consisting of static random access memory, dynamic random access memory, synchronous dynamic random access memory, and high-speed data-transmission synchronous dynamic random access memory.

15. The system of claim 12, wherein the processing unit is a central processing unit or microprocessor.

16. The system of claim 12, wherein the unit of the electronic device is an external peripheral device or embedded peripheral device.

17. The system of claim 12, wherein the module of the electronic device is an external peripheral device or embedded peripheral device.
